(19) United States
(12) Patent Application Publication
(10) Pub. No.: US 2024/0017174 A1
(43) Pub. Date: Jan. 18, 2024

(54) A System, Computer Implemented Method and Computer Program Product for Providing A Virtual Robotics Programming Competition

(71) Applicant: Robotify Labs Limited, Glasnevin, Dublin (IE)

(72) Inventors: Andrew Murphy, Terenure, Dublin (IE); Adam Dalton, Donaghmede, Dublin (IE); Evan Darcy, Kinsealy, Swords, Dublin (IE)

(21) Appl. No.: 18/245,127

(22) PCT Filed: Sep. 11, 2020
(86) PCT No.: PCT/EP2020/075528

§ 371 Date: Oct. 10, 2023

(51) Int. Cl. A63F 13/57; A63F 13/355; A63F 13/63

(52) U.S. Cl. CPC A63F 13/57; A63F 13/355; A63F 13/63

(57) ABSTRACT

This invention relates to a computer implemented method and a computer program product for providing a virtual robotics programming competition. The method comprising the steps of on a server, providing access for a remote client device to a physics library, a physics engine, a rendering engine and an application programming interface (API) mapping the functions of the physics engine to the rendering engine; setting a programming challenge for a user operating the remote client device; receiving a simulation computer program code for a virtual robot from the remote client device; miming the simulation computer program code in a challenge environment; and grading the performance of the simulation computer program code. The performance of the simulation computer program code can be judged based on the results of a live multiplayer robot battle. In this way, students may compete against each other in robotics competitions without the expense and other pitfalls of having to travel to remote locations.

### TECHNICAL FIELD

This invention relates to a system, a computer implemented method and a computer program product for providing a virtual robotics programming competition.

### BACKGROUND ART

Robotics competitions have become hugely popular around the World. Perhaps the biggest and most popular are those events hosted by First (Registered Trade Mark, 6) Robotics and VEX® Robotics. There are also several other competitions that students and enthusiasts may participate in. These competitions are generally recognized as a fantastic learning and team-building exercise for students of STEM (Science, Technology, Engineering and Mathematics) subjects in particular. Accordingly, participation in these events is encouraged wherever possible.

At present, these robotics competitions happen at various different venues around the World. Teams of students meet up after school hours to build, test and program their robots for weeks or months leading up to an event. Teams must then travel to the competition venue to compete with other teams. Although there are many positives to these robotics competitions, there are a number of problems with the existing model. Perhaps most importantly, the cost of participating in an event can be prohibitive, with costs often reaching in excess of $10,000 for teams to compete in bigger competitions such as FIRST 6 Robotics tournament. This presents a barrier to many talented young students from entering the competitions and testing their skills against their peers. In addition, there is always a safety concern when students are competing in any competition away from home and this usually requires an adult chaperone, increasing the cost and requiring time and resources of the adult. As a consequence, the robotics competitions are inaccessible to many students and the competitions suffer by excluding some of the brightest and best up-and-coming talented students and enthusiasts.

With remote learning becoming more and more prevalent, these excellent experiences are also in many cases no longer feasible as students are not able to collaborate with each other in the build, programming and testing of their robots in the same was as before, thereby removing the team building aspect and one of the core benefits and reasons for entering the robotics competitions in the first place. This has a tendency to dissuade students from entering and educators from promoting participation in the robotics competitions.

United States Patent Nos. U.S. Pat. Nos. 6,674,259, 7,193,384, 7,330,776, 8,014,897 U.S. Pat. No. 8,504,200 all in the name of Innovation First, Inc., disclose systems and methods for managing and controlling a robot competition. U.S. Pat. No. 6,569,012 in the name of TopCoder Inc., discloses systems and methods for providing coding competitions.

It is an object of the present invention to provide a computer implemented method, a computer program product, and a system that overcome at least one of the above-identified problems. It is a further object of the present invention to provide a useful alternative choice for the consumer.

### SUMMARY OF INVENTION

According to the invention there is provided a computer implemented method of providing a virtual robotics programming competition, the method comprising the steps of:
on a server, providing access for a remote client device to a physics library, a physics engine, a rendering engine and an application programming interface (API) mapping the functions of the physics engine to the rendering engine;
setting a programming challenge for a user operating the remote client device;
receiving, over a communication network, a simulation computer program code for a virtual robot from the remote client device;
running the simulation computer program code for the virtual robot received from the remote client device in a challenge environment; and
grading the performance of the simulation computer program code.

By having such an offering, this will allow teams of students to write programs to pit their robots against each other in a virtual environment. Since the competition is virtual, it means that teams can compete internationally or from very remote, rural areas. The computer implemented method according to the invention is more affordable and it is highly accessible, thereby obviating many of the pitfalls of the existing offerings. In addition, by having a physics library, a physics engine, a rendering engine and an application programming interface (API) mapping the functions of the physics engine to the rendering engine on a server accessible to the client devices, the client devices can be lean devices with the minimum of software required at the client side, and the content available to the client device users will be strictly controlled.

In one embodiment of the invention there is provided a computer implemented method in which the remote client device accesses the physics library, the physics engine, the rendering engine and the API through a web browser on the client device. This is seen as a particularly preferred embodiment of the present invention and will allow the user of the client device to simulate and program their virtual robot through a web browser, a practically ubiquitous feature on any computing or communications device. Ideally, the API will visually render the outcome of the PhysX simulation using Three.js. This will enable rich content to be simulated and displayed.

In one embodiment of the invention there is provided a computer implemented method in which the method comprises the steps of running the simulation computer program code for the virtual robot received from a plurality of remote client devices simultaneously in the challenge environment. In this way, multiple users may compete against each other in real time, in the challenge environment. The challenge environment may, for example, be an obstacle course, pitch, track or other space. In this way, teams can compete in real time, similar in many ways to a multiplayer video game, however with the advantage that they are programming a virtual robot to compete against other virtual robots.

In one embodiment of the invention there is provided a computer implemented method in which the method comprises displaying the virtual robot operated by the simulation computer program code of the other client device on each client device. In this way, it will be possible to have interactive engagements between different users in real time and it will be possible to gauge performance against the performance of other parties. This is made possible by opening a communications channel between two disparate devices and providing movement information of a first client device's virtual robot to the rendering engine being utilized by a second client device. In this way, the second client device may render the virtual robot of the first client device in the browser of the second client device.

In one embodiment of the invention there is provided a computer implemented method in which the method comprises receiving and running the simulation computer program code for the virtual robot in the challenge environment in real time. This is seen as a useful aspect of the present invention. In this way, operators of client devices can view other client devices in operation in real time. this will also enable competition between two robots in real time.

In one embodiment of the invention there is provided a computer implemented method comprising the step of the operator of a client device modifying their simulation computer program code for the virtual robot in real time. By having such a feature, the teams will run/modify their code in real time to overcome their opponent. This will teach students the importance of being able to adapt their code to meet certain challenges and to improve their code to address different obstacles.

In one embodiment of the invention there is provided a computer implemented method comprising the step of the operator of the client device using a block code editor on their client device to provide their simulation computer program code for the virtual robot.

In one embodiment of the invention there is provided a computer implemented method comprising the step of allowing a third party operating a third party device to view the challenge environment in which the simulation computer program code for the virtual robot received from the remote client device is being run. In this way, supporters, judges and other interested parties may be able to access the content in the challenge environment to see the progress of the virtual robot and the competition as it unfolds in real time. In this way, other users not competing may be a spectator in the battle or challenge in real time which means they can view the battle live but cannot interfere.

In one embodiment of the invention there is provided a computer implemented method in which the method further comprises the step of, on a server, providing access for a remote client device to a simulated 3D object. Again, by providing the simulated 3D objects, this can provide further structure and limit the components that the client devices can use in a competition.

In one embodiment of the invention there is provided a computer implemented method in which the method comprises the steps of:
on a client device, issuing a web page load request through a browser;
establishing a communication link between the client device and at least one other client device;
loading the API and the simulation computer program code onto each of the client devices;
simulating a 3D object in each of the client's browsers, and, for each subsequent frame:
   receiving a simulated 3D object manipulation instruction from one client device;
   updating the rendered simulated 3D object by using the physics engine to generate position and rotation data for the simulated 3D object and sending that position and rotation data to the rendering engine on each of the client devices;
   the rendering engine updating the rendered simulated 3D object based on the position and rotation data received from the physics engine and
   displaying the updated rendered simulated 3D object on each of the client devices.

This is seen as a particularly preferred embodiment of the present invention. In this way, a multiplayer environment is provided as actions of one client device's virtual robot will be reflected on another client device operated by another user.

In one embodiment of the invention there is provided a computer program product having program instructions loaded thereon that when executed on a computer, cause the computer to carry out the steps of:
on a server, providing access for a remote client device to a physics library, a physics engine, a rendering engine and an application programming interface (API) mapping the functions of the physics engine to the rendering engine;
setting a programming challenge for a user operating the remote client device;
receiving, over a communication network, a simulation computer program code for a virtual robot from the remote client device;
running the simulation computer program code for the virtual robot received from the remote client device in a challenge environment; and
grading the performance of the simulation computer program code.

In one embodiment of the invention there is provided a computer program product further comprising program instructions for performing the step of, permitting the remote client device to access the physics library, the physics engine, the rendering engine and the API through a web browser on the client device.

In one embodiment of the invention there is provided a computer program product further comprising program instructions for performing the step of running the simulation computer program code for the virtual robot received from a plurality of remote client devices simultaneously in the challenge environment.

In one embodiment of the invention there is provided a computer program product further comprising program instructions for performing the step of displaying the virtual robot operated by the simulation computer program code of the other client device on each client device.

In one embodiment of the invention there is provided a computer program product further comprising program instructions for performing the step of receiving and running the simulation computer program code for the virtual robot in the challenge environment in real time.

In one embodiment of the invention there is provided a computer program product further comprising program instructions for performing the step of permitting the operator of a client device to modify their simulation computer program code for the virtual robot in real time.

In one embodiment of the invention there is provided a computer program product further comprising program instructions for performing the step of permitting the operator of the client device to use a block code editor on their client device to provide their simulation computer program code for the virtual robot.

In one embodiment of the invention there is provided a computer program product further comprising program instructions for performing the step of allowing a third party operating a third party device to view the challenge environment in which the simulation computer program code for the virtual robot received from the remote client device is being run.

In one embodiment of the invention there is provided a computer program product further comprising program instructions for performing the step of, on a server, providing access for a remote client device to a simulated 3D object.

In one embodiment of the invention there is provided a computer program product further comprising program instructions for performing the step of:
on a client device, issuing a web page load request through a browser;
establishing a communication link between the client device and at least one other client device;
loading the API and the simulation computer program code onto each of the client devices;
simulating a 3D object in each of the client's browsers, and, for each subsequent frame:
receiving a simulated 3D object manipulation instruction from one client device;
   updating the rendered 3D object by using the physics engine to generate position and rotation data for the simulated 3D object and sending that position and rotation data to the rendering engine on each of the client devices;
   the rendering engine updating the rendered simulated 3D object based on the position and rotation data received from the physics engine and displaying the updated rendered simulated 3D object on each of the client devices.

In one embodiment of the invention there is provided a system for providing a virtual robotics programming competition, the system comprising:
a plurality of remote client devices;
a server having a physics library, a physics engine, a rendering engine and an application programming interface (API) mapping the functions of the physics engine to the rendering engine thereon, accessible to the remote client devices;
a communication network for conveying a simulation computer program code for a virtual robot from the remote client device;
a processor for running the simulation computer program code for the virtual robot received from the remote client device in a challenge environment; and
an evaluation module for grading the performance of the simulation computer program code.

In one embodiment of the invention there is provided a system in which the remote client devices each have a web browser for accessing the physics library, the physics engine, the rendering engine and the API.

In one embodiment of the invention there is provided a system in which the processor is configured to run the simulation computer program code for the virtual robot received from a plurality of remote client devices simultaneously in the challenge environment.

In one embodiment of the invention there is provided a system in which the processor is configured to display the challenge environment including the virtual robot operated by the simulation computer program code of the other client device on each client device.

In one embodiment of the invention there is provided a system in which the processor is configured for receiving and running the simulation computer program code for the virtual robot in the challenge environment in real time.

In one embodiment of the invention there is provided a system in which the processor is configured to permit the operator of a client device to modify their simulation computer program code for the virtual robot in real time.

In one embodiment of the invention there is provided a system comprising a block code editor on their client device to permit the client device to provide their simulation computer program code for the virtual robot.

In one embodiment of the invention there is provided a system in which the processor is configured to allow a third party operating a third party device to view the challenge environment in which the simulation computer program code for the virtual robot received from the remote client device is being run.

In one embodiment of the invention there is provided a system in which the server, has a simulated 3D object stored thereon accessible to the remote client devices.

In one embodiment of the invention there is provided a system in which the physics engine is a port of a C++ physics engine.

In one embodiment of the invention there is provided a system in which the physics engine is an emscripten port of a C++ physics engine.

In one embodiment of the invention there is provided a system in which the physics engine is PhysX.

In one embodiment of the invention there is provided a system in which the rendering engine comprises a web graphics library (WebGL).

In one embodiment of the invention there is provided a system in which the rendering engine comprises Three.js.

In one embodiment of the invention there is provided a system in which the physics engine is configured to support multi-threading.

In one embodiment of the invention there is provided a system in which the physics engine is configured to operate in a web worker.

In one embodiment of the invention there is provided a system in which there is provided an accessible memory and a plurality of simulated 3D objects stored in the accessible memory.

### BRIEF DESCRIPTION OF THE DRAWINGS

The invention will now be more clearly understood from the following description of some embodiments thereof given by way of example only with reference to the accompanying drawings, in which:—

FIG. 1 is a diagrammatic representation of a system in which the method according to the invention may be performed;

FIG. 2 is a schema of the simulator and its functional components.

### DETAILED DESCRIPTION OF THE DRAWINGS

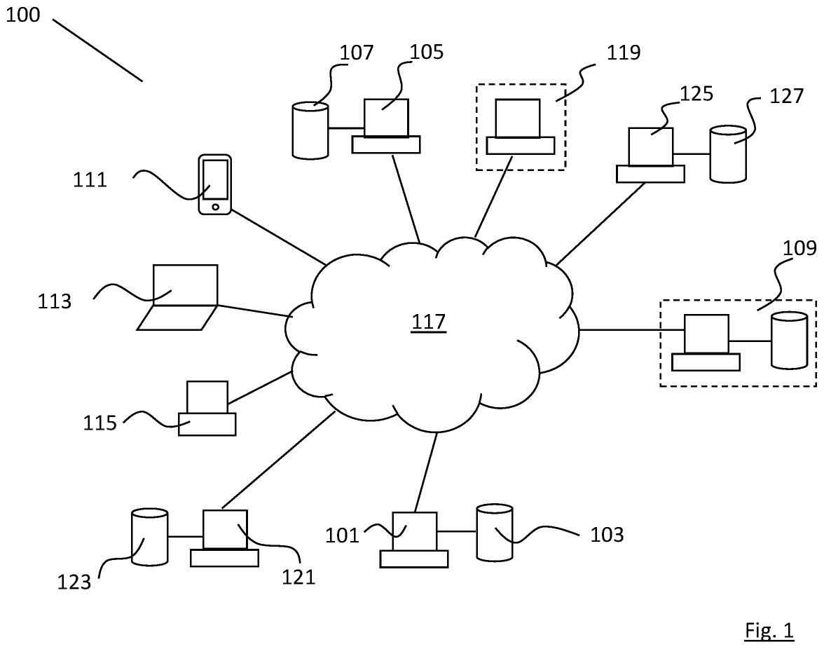

Referring to FIG. 1, there is shown a system in which the method according to the invention may be implemented, indicated generally by the reference numeral 100. The system comprises an operator computing device 101 with associated memory 103, and a client device 105 with associated memory 107. There is further shown a remote computing device 109, forming part of a content distribution network (CDN) of the operator, a plurality of third-party computing devices including a smart phone 111, a laptop computer 113 and a PC 115, all of which can communicate with each other through communications network 117. There is provided a web server 119 for hosting content for a content provider, the content being accessible to the client device 105. In addition, there are provided a further pair of client devices 121, 125, each of which has associated memory 123, 127 respectively. The content is also accessible by the client devices 121, 125, as will be described in more detail below. in the embodiment shown, only three client devices are shown for simplicity however it will be understood that there may be hundreds or indeed thousands of client devices that have access to the content stored on the server.

In use, the method comprises the initial steps of the operator generating a simulated 3D object and storing the simulated 3D object in memory 103. Furthermore, the operator stores a plurality of physics libraries in memory 103 along with a simulation application programming interface (API) linking a physics engine and a rendering engine, and, if desired a simulation computer program code (which may be used for demonstration purposes). The simulation API and simulation computer program code may be stored in the CDN 109, whereas the simulated 3D object and physics libraries may be stored on the web server 119. Alternatively, the simulation API, physics engine, rendering engine and the physics library may all be stored on the server 119.

The simulation API references a library of reusable code that can be invoked in the simulation computer program code. The simulation computer program code is the code that is written to create a particular simulation of a simulated 3D object. The simulation computer program code makes use of the simulation API library and will contain functions that can be found in the API library. Therefore, it will be necessary to load the API in order to run the simulation code. The API reduces the amount of code required. By this, what is meant is that the amount of code that is required to be written by the developer, i.e. the simulation computer program code. Strictly speaking, it is the features of the code library that allow for the code reduction as the API is the point of contact used for interaction between two running codes. The code library is written using best practices in that it is as efficient as possible.

The client device issues a web page load request using a browser (not shown) on the client's device 105. The method then comprises the steps of loading the simulation application programming interface (API) and the simulation computer program code onto the client's device 105 from the memory 103, (or from the CDN 109), importing the simulated 3D object and at least one of the physics libraries to the client's device 105 from the web server 119, and simulating the 3D object using the simulation API, the rendering engine and the physics engine having access to the imported physics library. The simulated 3D object is rendered in the client's browser, and, for each subsequent frame, the rendered simulated 3D object is updated by using the physics engine to generate position and rotation data for the simulated 3D object, that position and rotation data is sent to the rendering engine, and the rendering engine updates the rendered simulated 3D object based on the position and rotation data received from the physics engine before displaying the updated rendered simulated 3D object.

In the embodiment described above, the simulation computer program code for a virtual robot is code that is stored on the web server for demonstration purposes. This is useful to show some of the functionality of the virtual robot (i.e. the simulated 3D object). In use, once the client using the client device has seen the demonstration of the operation of the simulated 3D object (or indeed, a demonstration may not even be necessary for them), the client operating the client device will prepare their own simulation computer program code for a virtual robot. It is this code, developed by the client using the client device, that is then used to compete in the competition. For example, the competition may comprise a challenge environment, in this case a maze, and the virtual robot will have to be programmed to navigate through the maze in the fastest possible time. It will be possible to test each of the simulation computer program code for a virtual robot of each of the clients/users to see which robot is able to navigate the maze in the shortest time. the robots may be placed in the maze sequentially, or simultaneously, as will be described in more detail below in relation to a multiplayer environment.

Instead of client device 105, the client may use any of the client devices 111, 113, 115 shown, or indeed another client device 121, 125 capable of accessing the web server and displaying a web page. For example, a smartphone, an internet enabled television, a tablet, a phablet, a smart watch or the like could also be used to view the simulation.

Once the operator has completed the simulation of the virtual robot, the operator provides the content provider with API documentation that will allow the content provider to easily control their simulation with Javascript (Registered Trade Mark®) commands. If desired, the following steps may be taken in order to integrate the simulation into the content provider's web page.

In step 1, the operator provides the content provider with a folder of files containing any 3D assets and the physics library files. (Note: Any files that contain operator source code may be obfuscated using the tool htts://obfuscator.io/.) In step 2, the content provider places these files in a folder on their web server 119. In step 3, the operator will host a CDN (only part of which, computing device 109, is shown, that contains the simulation API as well as the simulation code. This must be loaded onto the client device in order for the client device to run the simulation. This allows the operator to easily make updates to the code. In step 4, the content provider will integrate the simulation into their web page with code similar to the following code segment 1, shown below:

[Code Segment 1]

```
// Load the CDN
  <script src=″ https://cdn.com/simbot.js ″></script>
  <script>
  var view = null, math = null;
  // Fetch the HTML container where the simulator will be injected
  var robotDiv = document.getElementById(′robotDiv′);
  var math = VIEW.math;
  var view = VIEW.engine;
  // Initialise the simulator into ‘robotDiv’
  view.init( { worker:true, export:true, ground:true, div:robotDiv,
  callback:demo } );
  </script>
```

The content provider is thereafter ready to begin simulations through their web server to third parties (operating a client device). In this way, it can be seen how a competition organiser can be provided with the apparatus to run a competition for students in a particular school, area or district. The operator provides the competition organiser with the tools for hosting the competition.

From a technical perspective, the method according to the present invention enables robotics simulations that were not previously possible to run in a native web browser. This is due in part to the port into Javascript 6 of Nvidia's 6 PhysX 6 4.1 physics library. Until now, the most powerful in-browser engine has been Ammo.js which, as of September 2020, is a Javascript port of a 2013 physics engine. The use of PhysX 4.1 allows for new simulation possibilities, such as tank physics, 4WD vehicle physics, joint articulation physics (for simulating robotics such as Robot Arms), wheel slip physics and more. The Javascript port of PhysX also offers significant improvements in friction and performance with high numbers of simulated objects. Previously, development with in-browser physics engines was a difficult task that required large amounts of complex code. For example, a simple demonstration simulation displaying a number of pyramids, each of which is constructed from a plurality of blocks, previously required 232 lines of code but using the API according to the present invention, now only requires 43 lines of code, a reduction of over 80%.

In order to port PhysX, in one embodiment Emscripten was used. Emscripten (www.emscripten.org) is a source-to-source compiler used to compile C and C++ code into JavaScript.

The method and in particular the API component of the present invention makes it possible to add simulated bodies to a 3D scene with minimal amounts of code required. In order to add a simulated entity, whether that is a simple cube or a 4WD vehicle, it often only requires a single line of code which contains the configuration options for the simulated entity. For example, to add a cube to the simulation using the API according to the present invention, the following code segment 2 would be required:
view.add({pos:[−10, 2.5, 0], size:[1,5,1], rot:[0,35,0] })
   [Code Segment 2]

In order to add a cube without the API according to the present invention, the code would look something like code segment 3 below:

[Code Segment 3]

const tmpMat = new THREE.Matrix4( );
const tmpVec2 = new THREE.Vector3( );
var stackGL, stackPX;
// create material and a box in physx
var matPX = physics.createMaterial(0.5, 0.5, 0.5);
var box = new Px.BoxGeometry(0.5, 0.5, 0.5);
var shape = createShape(box, matPX);
// set position for cube
tmpVec2.set(pos.x, pos.y, pos.z);
tmpMat.makeTranslation(tmpVec2.x, tmpVec2.y, tmpVec2.z);
stackGL.push(new THREE.Mesh(mesh, matGL));
stackPX.push(createDynamic(tmpMat, shape, 1));
glscene.add(stackGL[stackGL.length − 1]);
// create the box shape
function createShape(geometry, matPX)
{
var flags = new Px.ShapeFlags(Px.ShapeFlag.eVISUALIZATION.value |
Px.ShapeFlag.eSCENE_QUERY_SHAPE.value |
Px.ShapeFlag.eSIMULATION_SHAPE.value);
var shape = physics.createShape(geometry, matPX, false, flags);
flags.delete( );
return shape;
}
// add a rigidbody to the shape for collisions
function createDynamic(transform, shape, density)
{
var localTm = new Px.Transform(new Float32Array(transform.elements));
var dynamic = physics.createRigidDynamic(localTm);
localTm.delete( );
dynamic.attachShape(shape);
Px.RigidBodyExt.updateMassAndInertia(dynamic, density, null, false);
pxscene.addActor(dynamic, null);
return dynamic;
}

It can be seen therefore that the computation overhead and time to process the code will be significantly reduced. Another advantageous aspect of the API is that the API allows for automatic linking between the rendering and physics engine and provides simple API commands to do so. An example to add a 3D model with physics collisions using the API is illustrated in Code Segment 4 below:

Code Segment 4

```
// from the ‘duck’ 3D model, find the object called ′LOD3spShape′, scale
  it to 0.03, store in a variable called ‘model’
  var model = view.getMesh( ′duck′, ′LOD3spShape′, 0.03 );
  // Calculate an optimised collision shape for the model, store in a
  variable called
  ‘shape’
  var shape = view.toConvex( model );
  view.add({
  type:′convex′, // type ‘convex’ is for a loaded 3D model
  Mass:1, // Set mass of object
  pos:[ 0,0,0 ], // Set position of object
  Shape:shape, // The computed collision shape for the model
  Mesh:model, // The 3D model itself
  restitution:0.4 // Restitution value or ‘bouncy’ value
  })
```

In addition to the foregoing, the present invention also makes it possible to run multithreaded physics in a web browser which helps with performance when simulating a large number of objects at once. The simulator runs physics in a Javascript web worker by default, and there is no extra configuration required for convenience. In the present implementation of the invention, phy.js is being run in the web worker. Using the following code content from the code library:
worker=new Worker(isExport ? ‘./build/phy.min.js’: ‘./build/phy.js’);

a worker will be run using phy.min.js if the isExport Boolean is true, otherwise it will run phy.js in the Worker. It is possible to enable physics multithreading using the port of PhysX according to the invention. Multithreading is only supported on Google Chrome browser at the moment however it is envisaged that extension to other browsers will be readily understood to the skilled addressee. The only change required to allow for multi-threading is the following line of code, shown as code segment 5 below, illustrating the use of three threads, along with the alternative line of code for no multithreading:

Code Segment 5

```
  // use 3 threads
  dispatcher = Px.MultithreadCpuDispatcherCreate(3);
Instead of
  // use main thread
  dispatcher = Px.MultithreadCpuDispatcherCreate( );
```

These are functions that are built into the PhysX library. While this can increase performance on certain devices, there are some limitations of multithreading using the port of PhysX developed according to the present invention. First of all, the program memory cannot dynamically “grow”, so this means that the memory requirements are hardcoded at compilation time (For example: 128 MB). This is an Emscripten specific limitation. In order to circumvent the problem, it is possible to do a malloc/new (dynamic memory allocation), but it cannot exceed the hardcoded limit. This is troublesome because the operator must have a good understanding of the scene memory requirements, or allocate a high memory limit from the beginning (which can be a waste of resources). Secondly, the number of threads must also be hardcoded at compilation time (For example: 2 threads, etc.). This is because of PhysX itself and not Emscripten which is able to allocate threads dynamically. But this is problematic too, as the number of available threads depend on the user machine. For this problem, the following workaround may be used: as detecting the number of threads is possible from Javascript, if a version for each typical thread configuration (1,2,4,8) is compiled, there will be the opportunity to start the version that would best suit the host platform. In this way, the resources are used more effectively and the code will be processed more efficiently.

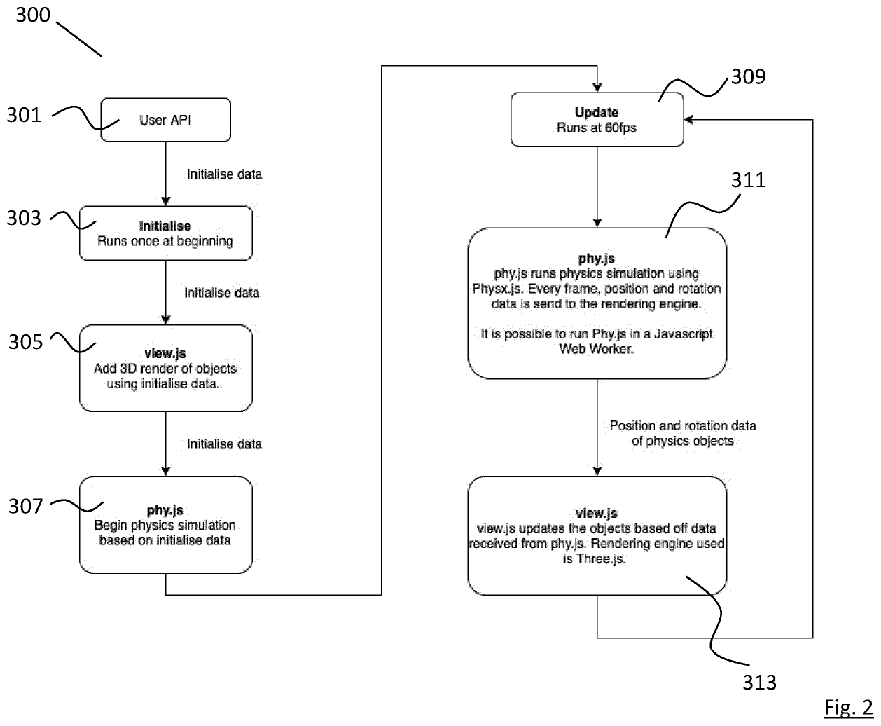

Referring now to FIG. 2, there is shown a schema of the simulator and its functional components, indicated generally by the reference numeral 300. The client uses User API in step 301 to begin the process. This includes step 303, an initialisation step, which sets the parameters for the simulation and runs once at the beginning. Thereafter, in step 305, the component view.js adds the 3D render of objects using the initialisation data and in step 307, the phy.js component begins the physics simulation based on the initialisation data. The simulation is updated in step 309. The updates run at 60 frames per second which will be practically seamless to a viewer. Once updated, simulation proceeds to step 311 in which the phy.js component runs the physics simulation using Physx.js. For each frame, the position and rotation data is sent to the rendering engine. It is possible to run the Phy.js in a Javascript web worker if desired. In step 313, the view.js will update the objects based on the data received from phy.js in the previous step. The rendering engine used is Three.js. Three.js is a cross-browser JavaScript Library and API used to create and display 3D graphics in a web browser. After the frame is rendered, the method reverts back to step 309, the update and then cycles through steps 311 and 313 for the simulation. If desired, a break may be introduced into the method so that it will only cycle through the steps 309, 311, 313 a predetermined number of times before completing the simulation.

It will be understood from the foregoing that there are numerous uses and benefits for the present invention. For example, it is envisaged that the simulated 3D object may be a piece of equipment, the web server may be operated by a manufacturer/supplier of that equipment and the client devices may be operated by contestants trying to complete a challenge using that equipment. The supplier of the equipment may for example, be seeking ways in which the equipment can complete a particular task in the most efficient manner or the shortest time, or using the least energy. The contestants can each simulate the operation of the equipment by writing a simulation computer program code for the piece of equipment and the simulation computer program code of each contestant can be evaluated. Alternatively, the content provider may be a provider of online games and the client device may be operated by a gamer, operating a robot or other device in a challenge against the clock or other users. This will be described in more detail below under the heading “Multiplayer”, which is a particular focus of the present application.

Alternatively still, the web server could be operated by a company or organisation for their design team (internal, external or both internal and external) and the design team may be able to access the simulation, evaluate the simulation and see if and how it could be improved prior to going into production. Similarly, the simulated 3D object could be a vehicle such as an airplane, helicopter or spacecraft, or several vehicles simulated together such as cars, motorcycles, trucks, boats or combinations thereof.

Multiplayer:

One particularly advantageous aspect of the present invention is the possibility to implement a multiplayer environment. The multiplayer API plugin, based on WebRTC, for the JS engine makes it simple to create multiplayer applications without the use of an external library or service. In this way, users of client devices can compete against each other in real time if desired.

The multiplayer plugin allows for (i) automatic matchmaking with other online users; (ii) a user to create a multiplayer server which other users can join; (iii) teams of users to play against/with each other; and (iv) an observer to be able to watch another user move an object in real time.

The multiplayer API is built into the core engine and inherits the same code structure, for example, the “view.add” feature. However, in order to enable multiplayer objects, the API command “net.add” is used instead of the command “view.add”. In this way, it is simple to add multiplayer functionality to an existing piece of code. In this way, time consuming and non-reusable multiplayer integrations are avoided. In addition, there is also provided client-side prediction built into the multiplayer engine which means that when viewing the other player on the client device's screen, their movements will appear smooth even on slower internet speeds.

More specifically, net.add is intended to be a drop-in replacement for view.add, with a few optional multiplayer-related parameters. it works by sending a request to the server to add a new rigid body, vehicle, or articulation. The server will then echo the request to all connected clients. The end result is each player internally calls view.add so each player can see the added object. On every physics step, the “simulatee” will send the object's position and rotation to the server, which then echos it back to other players. Some physics steps may be skipped to avoid buffer overflows, resulting in movement that appears stuttery to other players. To fix this, client-side prediction is used. The object is kinematic to everyone except the “simulatee”. This prevents other players from affecting this body in the physics simulation. Only the chosen “simulatee” can apply forces to the object.

In some embodiments, it may be preferred to allow a third party's actions impinge on a user's simulated 3D object. For example, if another user's simulated 3D object should collide with a first user's 3D object or if another user's simulated 3D object should “fire” at a first user's 3D object. In those instances, it is envisaged that the computer-implemented method, computer program product and system will calculate the force applied by the opponent at the point of contact based on their mass and acceleration. The method, computer program product and system can then apply that force as a vector to the simulatee's 3D object and echo the results to other users/players.

Similarly, if one user's simulated 3D object “shoots” at another user, the method, computer program product and system may determine whether that shot hit or missed the first user's simulated 3D object, and, if the shot hit and if desired, where on the first user's simulated 3D object the shot landed. The method, computer program product and system may thereafter determine a “damage quantum” caused by the shot, and may use that damage quantum in a scoring of the contest and/or may subtract that damage quantum from a “life value” of the first user's simulated 3D object. If the “life value” of the first user's simulated 3D object is reduced to zero, that user may be defeated, locked out of the simulation, may have points deducted from their score, they may be “re-spawned”, and/or the other competitor may be awarded points/additional functionality for causing the damage.

As will be understood, client-side prediction is a method of ‘smoothing’ out player movements. If this were not present, the robot's movement could appear very choppy as the position would not update until the positional data is received from the server. Generally speaking, data from the server is not received fast enough to support a 60 fps simulation so client-side prediction is used to ‘fill in the gaps’. It operates by predicting the position and rotation of a simulated 3D object based on the last available position, rotation and velocity. For example, a velocity of 1 m/s forward is received from the server, the velocity received matches the last received velocity. It is safe to assume that the object is moving forward at a constant speed of 1 m/s so the object will continue to move forwards until a different velocity is received from the server. There are also lerp and slerp functions applied for further smoothing. E.g if a position of 0,0 followed by 0,10 is received, a lerp/slerp function will be used to interpolate between the two values resulting in a smooth animation to the target position. Without lerp or slerp, it would be instantaneous and appear ‘choppy’.

The multiplayer API is able to create an entire client-server network in-browser. This is achieved using an intermediary signaling server to establish the connection. Thereafter, connections between users are direct and once established, don't require a middleman (i.e. the signaling server is no longer required, if preferred), meaning lower latency and extremely low cost. A master server, more commonly referred to as a signalling server, which may be provided by the operator computing device 101 or other device, is provided. The server helps with the initial connection establishment between users (players). The master server is designed to be as lightweight as possible and exchange minimal amounts of information. Once the connection is established, the master server is no longer needed until another client wishes to join the server.

In order to keep track of the competition and scoring, if necessary, the present invention may comprise a communications methodology in which a request will be sent to the master server (competition operator's database) to create/update the status and details of a competition match. A further request may be performed to create/fetch a team object based on players in the game. A further request may be performed to create a match object which will detail what teams are playing in the event, what environment is to be used and more. At the end of the game, a request may be made to mark the match object as ‘completed’. In addition, it is envisaged that multiple requests may be made during the game to update the score of the match. It is envisaged that there will be a suite of virtual competition management tools allowing the provider to create custom distributions of competitions to automatically manage fixture scheduling, fixture dispute management, leaderboards and team practicing.

The in-browser client-server network is achieved using webrtc to create direct connections between players and a signalling server (also referred to it as the master server) to help establish these connections. The server holds a list of rtcpeerconnections, one for each connected client. Each client only has one rtcpeerconnection, to the server. In order for a client to communicate to other clients, it must relay information through the server.

More specifically, when a new client wants to join, the following steps may be followed (note steps 5 to 9 inclusive are understood to be standard procedure for using webrtc). First of all, a client will connect to the master server. Secondly, the client sends a “login” command to the master server containing username and name of the app they are wanting to play. Thirdly, the master server responds with a list of servers that are available to join. Thereafter, in step four, the user selects a server and in step five, a new RTCPeerConnection is then created. In step six, the connection creates an “offer” that is sent to the server it wants to join, using the master server as a relay between them and in step seven, the server responds to the offer with an “answer”, again using the master server as a relay. In step eight, both client and server send each other “ICE candidates” using the master server as a relay. ICE candidates are a set of potential IP addresses, ports, etc. that the server and client can connect to in order to establish a direct connection between them. In step nine, using the provided offer/answer/ICE candidates, the client and server connect to each other and thereafter in step ten, the client closes its connection to the master server. Creating a server is as simple as clicking a “host” button on a user interface. The newly created server and master server will maintain a connection for as long as the newly created server is open. This allows the master server to notify the newly created server when a client is attempting to join, beginning the webrtc signalling process.

Observers/spectators are the result of a player not creating a simulated 3D object (using net.add and view.follow) that they control. They are still able to watch the physics simulation but are unable to participate due to not adding their own body. It is envisaged that if desired, a user may be restricted from being able to create a simulated 3D object so that they can only have observer status.

One alternative way in which the present invention could be implemented would be the use of websockets however these are not deemed entirely suitable. Websockets are slower (due to indirect connection between players) and more expensive (due to the need to host potentially hundreds of servers). It is understood that it is possible to integrate a multiplayer experience into Playcanvas (Registered Trade Mark) but the developer must use an external service and API in order to do so. It is not immediately apparent how a multiplayer game could be built using Playcanvas, however the API according to the invention makes it very easy to do, which enables multiplayer functionality to be rapidly deployed using the API according to the present invention.

In many ways, the simple shorthand API for creating a networked physics simulation is what sets the present invention apart from the existing offerings. There are a series of multiplayer “extensions” that make multiplayer integration fast and easy: core.js, to manage connections automatically with a single line of code; body.js, to manage creation, deletion, and updating of physics objects in the simulation; sound.js, to play 3d positional sound effects across all users' devices; chat.js, to provide communication functionality between user devices; and team.js, for organizing players into teams.

Referring once more to FIG. 1, it will be appreciated that the operator computing device 101 may provide a “game” environment in which multiple 3D devices can populate and operate. This game environment may be distributed via the CDN 109. Once each of the client devices 105, 121, 125 has the game environment loaded thereon, one or more of the client devices may populate the game environment with their simulated 3D object. The simulated 3D object may be, for example, a vehicle such as a car, a spacecraft, a boat or other craft, an avatar such as a fighter, a soldier, an athlete, a fictional character such as a cartoon character from the Marvel (Registered Trade Mark,®) franchise or the like.

One of the client devices may populate the environment with their simulated 3D object and manipulate their simulated 3D object in the environment while the other client devices are able to view the simulated 3D object of the first client device progress through the environment. The environment could be, but is not limited to, a room, a ring such as a boxing ring or a cage, an ocean, a racetrack, a football field, a baseball arena, a landscape, a city, an island, a planet, outer space or another simulated environment. Alternatively, two or more of the client devices are able to populate the environment with their own simulated 3D objects simultaneously. Rendering information about the simulated 3D object(s) is transmitted to the other client device(s) so that it may be rendered on the other client device(s). In this way, the simulated 3D objects are also configured so that they are able to interact with each other.

For example, the simulation may comprise a competition to develop a robot using certain limited components, e.g. a given number of wheels, motors, saws, clamps, hammer arms, bodywork etc.. Each client device user can then construct their robot using the limited components and thereafter simulate their robot in the environment. The competitions can range from racing games, to robot battles with laser guns. The robot of one client device can then compete with the robot of the other client device(s) in time trial challenges, maneuverability challenges, or in “battles” to defeat the other robot of the other client device(s). In other words, it is possible to implement a “Robot Wars” 6 style competition in which robots developed by different users are used to compete against other robots and either break the other robots or push those robots into certain areas, using the method according to the invention.

It is envisaged how the environment could be a landscape of the planet Mars and the robots each have to navigate around the planet's surface, performing tasks, navigating difficult terrain and traversing canyons or other obstacles. The precise nature of the task or the environment is not important, what is important is that the different clients are able to view simulated 3D objects on other client devices, and preferably interact with those other client devices' simulated 3D objects. It is envisaged that the challenge environment comprises a simulated environment configured in a gamified manner where a player/programmer must control their character/robot to complete a certain game-themed task.

In the embodiments described, it is mentioned that simulation code and API may be stored on a different CDN to the simulated 3D objects and physics libraries (the operator provides the content provider with a folder of files). In addition, it is conceived that in another embodiment, the system, method and computer program product according to the present invention will host all assets on the same CDN. For the operation of the invention, it is not limited to where the files are stored remotely provided they are loaded on the webpage when required. For example, all the files can be stored by the content provider or they can all be stored by the operator.

One structure, in which users may compete against each other is described below for illustrative purposes only. Various modifications could be made without departing from the present invention. In this embodiment, the user experience will be as follows:

First of all, a user logs into a Robotify® (or other host) server and navigates to the “Roboduel” section. Secondly, the user can view all robot competitions currently open for registration. Thirdly, the user can view the details of the robot competition and register a team. If desired, there may be a registration fee. Fourth, registration will stay open until a set deadline. On the deadline, match fixtures will be posted and emailed to users (the exact logistics will vary from competition to competition, e.g. some competitions are challenge based where the user simply submits a sample code before a deadline, projects are tested and a winner is announced that way). Match fixtures are a schedule of all the matches that will take place, it will show which teams are competing at which dates/time. Join links will be generated for all fixtures that only become live on the date and time. Fifth, in the time leading up to a scheduled match, the team will be reminded by email about their upcoming match. Sixth, the team joins the match at the agreed upon date and time. Seventh, the team writes new code or uses prepared code to program their robot against their opponent. The teams compete against each other. Eighth, a winner of the match is declared (it is conceivable that the competition may be a league and indeed the task may be one in which it is possible for the two teams to draw. Points can be awarded accordingly). Ninth, all fixture matches will be played out and an overall winner is declared. There may be incentives for winning the competition which may include a contract to supply goods/services, a term of employment, a job offer, a financial reward, goods and/or services. In return, the rights to the simulation computer program code may be assigned to the operator of the competition.

For example, it is envisaged that the competition may be held by a self-operating lawn mower manufacturer. The manufacturer of the self-operating lawn mower manufacturer may wish to develop the most efficient ways for their self-operating lawn mower to traverse a lawn, doing a thorough job and navigating certain obstacles along the way. In this instance, the self-operating lawn mower is the “robot”. They may put this competition out to the public and provide a simulated 3D object that is representative of their self-operating lawn mower, including the sensor inputs etc.

The members of the public will then compete with each other to write the best simulation computer program code to operate their virtual robot (the simulation of the 3D object). The lawn mower manufacturer may provide certain challenge environments, which may include different shaped lawns, lawns with garden ornaments located in the lawn, flower beds, trees, kennels or other garden furniture located on or abutting the lawn, trampolines, paddling pools and other obstacles that might be found on a person's lawn. The simulation computer program code that can best navigate these obstacles will be the winner and the manufacturer will, in return for the code and shortening their development cycle, pay a reward to the developer of the simulation computer program code.

It will be understood that various parts of the present invention are performed in hardware and other parts of the invention may be performed either in hardware and/or software. It will be understood that the method steps and various components of the present invention will be performed largely in software and therefore the present invention extends also to computer programs, on or in a carrier, comprising program instructions for causing a computer or a processor to carry out steps of the method or provide functional components for carrying out those steps. The computer program may be in source code format, object code format or a format intermediate source code and object code. The computer program may be stored on or in a carrier, in other words a computer program product, including any computer readable medium, including but not limited to a floppy disc, a CD, a DVD, a memory stick, a tape, a RAM, a ROM, a PROM, an EPROM or a hardware circuit. In certain circumstances, a transmissible carrier such as a carrier signal when transmitted either wirelessly and/or through wire and/or cable could carry the computer program in which cases the wire and/or cable constitute the carrier.

It will be further understood that the present invention may be performed on two, three or more devices with certain parts of the invention being performed by one device and other parts of the invention being performed by another device. The devices may be connected together over a communications network. The present invention and claims are intended to also cover those instances where the system and/or method is operated across two or more devices or pieces of apparatus located in one or more locations. In this specification the terms “comprise, comprises, comprised and comprising” and the terms “include, included, includes and including” are all deemed interchangeable and should be afforded the widest possible interpretation. The invention is not limited to the embodiments hereinbefore described but may be varied in both construction and detail within the scope of the appended claims.

1. A computer implemented method of providing a virtual robotics programming competition, the method comprising the steps of:
on a server, providing access for a remote client device to a physics library, a physics engine, a rendering engine and an application programming interface (API) mapping the functions of the physics engine to the rendering engine;
setting a programming challenge for a user operating the remote client device;
receiving, over a communication network, a simulation computer program code for a virtual robot from the remote client device;
running the simulation computer program code for the virtual robot received from the remote client device in a challenge environment; and
grading the performance of the simulation computer program code.

2. The computer implemented method as claimed in claim 1 in which the remote client device accesses the physics library, the physics engine, the rendering engine and the API through a web browser on the client device.

3. The computer implemented method as claimed in claim 1 in which the method comprises the steps of running the simulation computer program code for the virtual robot received from a plurality of remote client devices simultaneously in the challenge environment.

4. The computer implemented method as claimed in claim 3 in which the method comprises displaying the virtual robot operated by the simulation computer program code of the other client device on each client device.

5. The computer implemented method as claimed in claim 1 in which the method comprises receiving and running the simulation computer program code for the virtual robot in the challenge environment in real time.

6. The computer implemented method as claimed in claim 5 comprising the step of the operator of a client device modifying their simulation computer program code for the virtual robot in real time.

7. The computer implemented method as claimed in claim 1 comprising the step of the operator of the client device using a block code editor on their client device to provide their simulation computer program code for the virtual robot.

8. The computer implemented method as claimed in claim 1 comprising the step of allowing a third party operating a third party device to view the challenge environment in which the simulation computer program code for the virtual robot received from the remote client device is being run.

9. The computer implemented method as claimed in claim 1 in which the method further comprises the step of, on a server, providing access for a remote client device to a simulated 3D object.

10. A computer implemented method as claimed in claim 1 in which the method comprises the steps of:
on a client device, issuing a web page load request through a browser;
establishing a communication link between the client device and at least one other client device;
loading the API and the simulation computer program code onto each of the client devices;
simulating a 3D object in each of the client's browsers, and, for each subsequent frame:
receiving a simulated 3D object manipulation instruction from one client device;
updating the rendered simulated 3D object by using the physics engine to generate position and rotation data for the simulated 3D object and sending that position and rotation data to the rendering engine on each of the client devices;
the rendering engine updating the rendered simulated 3D object based on the position and rotation data received from the physics engine and displaying the updated rendered simulated 3D object on each of the client devices.

11. The computer program product having program instructions loaded thereon that when executed on a computer, cause the computer to carry out the steps of:
on a server, providing access for a remote client device to a physics library, a physics engine, a rendering engine and an application programming interface (API) mapping the functions of the physics engine to the rendering engine;
setting a programming challenge for a user operating the remote client device;
receiving, over a communication network, a simulation computer program code for a virtual robot from the remote client device;
running the simulation computer program code for the virtual robot received from the remote client device in a challenge environment; and
grading the performance of the simulation computer program code.

12. (canceled)

13. (canceled)

14. (canceled)

15. (canceled)

16. (canceled)

17. (canceled)

18. (canceled)

19. (canceled)

20. The computer program product as claimed in claim 11 further comprising program instructions for performing the step of:
on a client device, issuing a web page load request through a browser;
establishing a communication link between the client device and at least one other client device;
loading the API and the simulation computer program code onto each of the client devices;
simulating a 3D object in each of the client's browsers, and, for each subsequent frame:
receiving a simulated 3D object manipulation instruction from one client device;
updating the rendered simulated 3D object by using the physics engine to generate position and rotation data for the simulated 3D object and sending that position and rotation data to the rendering engine on each of the client devices;
the rendering engine updating the rendered simulated 3D object based on the position and rotation data received from the physics engine and displaying the updated rendered simulated 3D object on each of the client devices.

21. A system for providing a virtual robotics programming competition, the system comprising:
a plurality of remote client devices;
a server having a physics library, a physics engine, a rendering engine and an application programming interface (API) mapping the functions of the physics engine to the rendering engine thereon, accessible to the remote client devices;
a communication network for conveying a simulation computer program code for a virtual robot from the remote client device;
a processor for running the simulation computer program code for the virtual robot received from the remote client device in a challenge environment; and
an evaluation module for grading the performance of the simulation computer program code.

22. The system as claimed in claim 21 in which the remote client devices each have a web browser for accessing the physics library, the physics engine, the rendering engine and the API.

23. The system as claimed in claim 21 in which the processor is configured to run the simulation computer program code for the virtual robot received from a plurality of remote client devices simultaneously in the challenge environment.

24. The system as claimed in claim 23 in which the processor is configured to display the challenge environment including the virtual robot operated by the simulation computer program code of the other client device on each client device.

25. The system as claimed in claim 20 in which the processor is configured for receiving and running the simulation computer program code for the virtual robot in the challenge environment in real time.

26. The system as claimed in claim 25 in which the processor is configured to permit the operator of a client device to modify their simulation computer program code for the virtual robot in real time.

27. The system as claimed in claim 21 comprising a block code editor on their client device to permit the client device to provide their simulation computer program code for the virtual robot.

28. The system as claimed in claim 21 in which the processor is configured to allow a third party operating a third party device to view the challenge environment in which the simulation computer program code for the virtual robot received from the remote client device is being run.

29. (canceled)

30. (canceled)

31. (canceled)

32. (canceled)

33. (canceled)

34. (canceled)

35. (canceled)

36. (canceled)

37. (canceled)
